(19) United States
(12) Patent Application Publication
(10) Pub. No.: US 2014/0027421 A1
(43) Pub. Date: Jan. 30, 2014

(54) Method of Determining a Focal Point or Beam Profile of a Laser Beam in a Working Field

(71) Applicant: TRUMPF Laser GmbH + KG, Schramberg (DE)

(72) Inventor: Thomas Notheis, Schramberg (DE)

(73) Assignee: TRUMPF Laser GmbH + KG, Schramberg (DE)

(21) Appl. No.: 14/040,896

(22) Filed: Sep. 30, 2013

Related U.S. Application Data
(63) Continuation of application No. PCT/EP2012/054896, filed on Mar. 20, 2012.

(30) Foreign Application Priority Data
Mar. 31, 2011 (DE) 102011006553.9

(51) Int. Cl. G01J 1/42; B23K 26/08

(52) U.S. Cl. CPC G01J 1/4257; B23K 26/08
USPC 219/121.81; 356/123; 356/121

(57) ABSTRACT

In a method for determining the focal point or the beam profile of a laser beam, which can be deflected in the x and y directions by a scanner optic or an x-y-movement unit and can be displaced in the z direction by a focusing optic or a z-movement unit, at a plurality of measurement points in the two-dimensional working field or three-dimensional working space of the laser beam. An aperture diaphragm, followed by a detector, is arranged at each measurement point. At each measurement point, for x-y-focal point or beam profile measurements, the laser beam is moved by the scanner optic or the x-y-movement unit in an x-y-grid over the measurement aperture in the aperture diaphragm, and, at each grid point, the laser power is measured by the detector, the scanner axis of the scanner optic or the x-y-movement unit being stationary. For z-focal point measurements, the laser beam is displaced by the focusing optic or the z-movement unit in the z direction within the measurement aperture in the aperture diaphragm. The laser power is measured by the detector at each grid point. The focal point and/or the beam profile of the laser beam is then determined at each measurement point from the measurement values.

### CROSS REFERENCE TO RELATED APPLICATIONS

This application is a continuation of and claims priority under 35 U.S.C. §120 to PCT Application No. PCT/EP2012/054896 filed on Mar. 20, 2012, which claimed priority to German Application No. 10 2011 006 553.9 filed on Mar. 31, 2011. The contents of both of these priority applications are hereby incorporated by reference in their entirety.

### TECHNICAL FIELD

The disclosure relates to methods, devices and systems for determining a focal point or beam profile of a laser beam in a two-dimensional working field or three-dimensional working space of the laser beam.

### BACKGROUND

Tool Centre Point (TCP) of a laser tool, i.e., a focal point of a laser beam, is hard to be measured with ease. Optics with focal lengths in a region of ≧400 mm have been used, for example, when operating in an “on-the-fly” mode in which two movements are superimposed.

In some cases, an x-y-focal point of a laser beam is determined by deflecting the laser beam with a scanner optic in x and y directions in a working field. An aperture diaphragm with a power detector arranged behind the aperture diaphragm is located at a specific, fixed measurement point in the working field. A diameter of the aperture diaphragm is based on a focal diameter of the laser beam or corresponding thereto. To obtain an x-y-focal point measurement, the laser beam is moved across the measurement aperture, such that a Gaussian distribution of the measured power is obtained for the laser beam. Inaccuracies arise as a result of a dragging delay of the laser beam moving across the measurement aperture, which is corrected by averaging the measured power data. However, it is difficult to measure an entire working field or working space in this manner.

### SUMMARY

Implementations for the present disclosure feature methods of measuring a property of a laser beam, such as an x-y- or z-focal point or a beam profile of the laser beam.

One aspect of the invention features a method of determining a property of a laser beam, where the property comprises at least one of an x-y-focal point or a beam profile. The method includes moving the laser beam to each of a plurality of measurement points in a working area and, at each measurement point, adjusting a position of the laser beam to each of a plurality of grid points of an x-y-grid across a measurement aperture defined in an aperture diaphragm. With the laser beam positioned at each grid point, a power value of the laser beam is detected using a detector arranged behind the aperture diaphragm, and at each measurement point, the property of the laser beam is determined from the detected power values.

In some examples, moving the laser beam includes deflecting the laser beam in x and y directions by a scanner optic or an x-y-movement unit. In some cases, detecting the power value comprises keeping a scanner axis of the scanner optic or the x-y-movement unit stationary during the detection.

In some embodiments in which the determined property is the x-y-focal point, the aperture diaphragm has a diameter corresponding approximately to a focal diameter of the laser beam.

In some embodiments in which the determined property is the x-y-focal point, the x-y-grid has an edge length of approximately 5 to 100 times a focal diameter of the laser beam. In some cases,

the x-y-grid defines a grid distance between the grid points of approximately 0.01 to 1 mm.

In some cases adjusting the position of the laser beam includes adjusting the position of the laser beam across multiple apertures of differing sizes.

In some embodiments in which the determined property is the beam profile, the aperture diaphragm is of a diameter substantially smaller than a focal diameter of the laser beam.

Some embodiments also include arranging the aperture diaphragm consecutively at each of the plurality of measurement points.

The working area may be a two-dimensional working field of the laser beam or a three-dimensional working space of the laser beam, for example.

In some cases the aperture diaphragm includes an aperture plate defining a plurality of apertures that correspond to the measurement points. Each of the plurality of apertures in the aperture plate may be followed by a respective detector that detects the laser power at the measurement point corresponding to the aperture, or the plurality of apertures in the aperture plate may be followed by a common detector that detects the laser power at each of the measurement points.

Some embodiments of the method include displacing the position of the laser beam to each of a plurality of z-grid points along the z direction within the measurement aperture in the aperture diaphragm at each measurement point. With the laser beam positioned at each z-grid point, a second power value of the laser beam is detected by the detector, and at each measurement point, a z-focal point of the laser beam is determined from the detected second power values. In some cases the z-grid points are spaced along the z direction by a z-direction spacing of approximately 0.1 to 1 mm.

Another aspect of the invention features a system for determining a property of a laser beam. The system includes an x-y-beam positioner configured to position a laser beam in x and y directions across a working area; a z-direction beam positioner for displacing the laser beam in a z direction normal to the working area; and at least one aperture diaphragm positioned within the working area and associated with a beam power detector.

In some embodiments the x-y-beam positioner includes at least one of a scanner optic and an x-y-movement unit.

In some examples the z-direction beam positioner includes at least one of a focusing optic and a z-movement unit.

Another aspect of the invention features a method of determining a focal point of a laser beam along a z direction along which the laser beam extends. The method includes moving the laser beam to each of a plurality of measurement points in a working area perpendicular to the z direction, and at each measurement point, displacing a position of the laser beam to each of a plurality of points spaced in the z direction within a measurement aperture defined in an aperture diaphragm. With the laser beam positioned at each point, a power value of the laser beam is detected by a detector arranged behind the aperture diaphragm, and at each measurement point, the focal point of the laser beam is determined from the detected power values.

Another aspect of the invention features a method of operating a laser beam to process a workpiece across a working area. The method includes determining a property of the laser beam at multiple points across the working area, according to the method taught herein; transmitting one or more offset correction values based on the determined property to a controller of the laser beam; and then processing the workpiece as a function of the one or more offset correction values.

In some embodiments the controller of the laser beam comprises at least one of a scanner optic and an x-y movement unit.

In some implementations, the x-y- or z-focal point of the laser beam can be measured with an accuracy of approximately +50 μm in the x and y directions and ±1 mm in the z direction, at a plurality of measurement points distributed over the working area (e.g., an entire two-dimensional working field and/or three-dimensional working space of the laser beam).

In some examples, the x-y-focal point is measured in a stationary manner at each x-y-grid point, i.e., a scanner axis of the scanner optic or the x-y-movement unit is stationary during the measurement, thereby avoiding inaccuracies due to a dragging delay. This measurement is both rapid and accurate, as well as being simple, reliable and cost-effective. This focal point measurement is not dependent on wavelength and can also be used for long focal lengths.

It is also possible to measure the entire working field or working space either by arranging the same aperture diaphragm at different measurement points or by arranging an aperture diaphragm at each measurement point. The x-y-focal point or TCP and/or the beam profile of the laser beam at the respective measurement points can be determined from the measurement values and can, for example, be transmitted as an offset correction value to a controller of the scanner optic or the x-y-movement unit.

In certain cases, for z-focal point measurements, the laser beam is displaced in z direction within the measurement aperture, for example, within a grid distance of from approximately 0.1 to 1 mm (depending on the focal length of the laser beam). The peak value (z-focal point) is calculated from the measurement values and for example, transmitted as an offset correction value to the controller of the focusing optic or the z-movement unit.

For particularly rapid focal point measurements, an aperture diaphragm containing one or more additional apertures adjacent to or around the actual measurement aperture can be used. The measurements are taken starting from the measurement aperture with the largest diameter. Depending on a difference between the actual focal point and that assumed by the controller, the laser beam passes in full or in part through the respective apertures in the aperture diaphragm and the corresponding measurement values are detected. This makes it possible to check the focal point in the x, y and z directions with ease and to adapt the grid in accordance with the difference between the actual focal point and that assumed by the controller.

For working field measurements, an aperture plate comprising a plurality of apertures is preferably used. The focal point is measured at each measurement aperture, thereby measuring the working field in this plane and enabling it to be corrected. The field measurement is not dependent on wavelength. If the aperture plate is used in conjunction with an adjusting basket or is attached on a reference plane, it is possible to calibrate the working field in situ in the laser processing system using the respective laser. A working field measurement of this type is preferably carried out in a plurality of planes, thereby measuring the working space and enabling it to be calibrated.

For beam profile measurements, a measurement aperture with an aperture diameter many times smaller than the focal diameter of the laser beam can be used. The beam profile can be established from the measurement values thus obtained, and can be used for further analysis.

The aperture diaphragm may be designed in such a way that it takes up energy absorbed during measurement without heating up excessively. For this purpose, the aperture edge of the aperture diaphragm may be countersunk and the aperture diaphragm may be gold-plated for example.

The detector may be located directly behind the measurement aperture in the aperture diaphragm and may take the form of a simple photodiode. Alternatively, an optical fiber cable, which relays the light to the detector located elsewhere, may be inserted into the measurement aperture. In the case of an aperture plate comprising a plurality of apertures, a single detector may also be provided rather than a plurality of detectors following respective apertures, and a diffuser being can be arranged between the aperture plate and the common detector in order to direct the incident light received via the apertures to the single detector.

Further advantages of the invention are set out in the description and the drawings. The features described above and those specified below may also be used in isolation or may be combined in any desired manner. The embodiments shown and described are not to be understood as an exhaustive list but rather as having an illustrative nature in order to describe the invention.

### DESCRIPTION OF DRAWINGS

FIG. 1 is a schematic view of a first embodiment of a laser processing system.

FIG. 2 shows the x-y-measurement grid of a measurement sensor of the system shown in FIG. 1.

FIG. 3 is a schematic view of a second embodiment of a laser processing system.

FIG. 4 shows an aperture diaphragm comprising a plurality of measurement apertures with different diameters.

### DETAILED DESCRIPTION

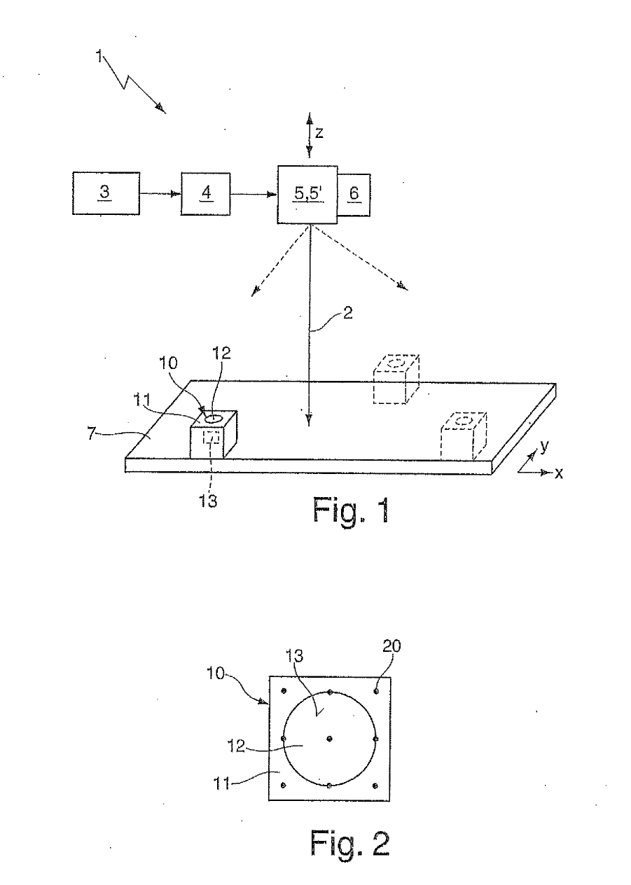

The laser processing system 1 shown in FIG. 1 processes workpieces (not shown) by means of a laser beam 2 generated by a laser 3. A focal length of the laser beam 2 can be modified by using a focusing optic 4, and the laser beam can be deflected in x and y directions using a scanning optic 5 in order to process a workpiece. The scanning optic 5 can be displaced in the z direction by a z-movement unit 6. An x-y-working field which can be scanned by the laser beam 2, in the present case corresponding to a workpiece support, is denoted by reference numeral 7.

A measurement sensor 10, which has an aperture diaphragm 11 with a power detector 13 provided behind a measurement aperture 12 in the aperture diaphragm 11, is arranged on said working field 7. As indicated by broken lines in FIG. 1, said measurement sensor 10 may be arranged at any desired measurement point in the working field 7.

For x-y-focal point measurements of the laser beam 2, the aperture diameter of the aperture diaphragm 11 corresponds approximately to the focal diameter of the laser beam 2. As shown in FIG. 2, at a plurality of measurement points the laser beam 2 is moved, either by the scanner optic 5 or an x-y-movement unit 5′, in an x-y-grid over the measurement aperture 12 in the aperture diaphragm 11. At each of the grid points 20 (in this case nine grid points are shown by way of example) the laser power is measured by the detector 13, the scanner axis of the scanner optic 5 or the x-y-movement unit 5′ being stationary during the measurement. The edge lengths of the x-y-grid are preferably 5 to 100 times the focal diameter of the laser beam 2 and the grid distance of the x-y-grid is preferably of from approximately 0.01 to 1 mm. The x-y-focal point of the laser beam 2 at the respective measurement point can be determined from the measurement values and may be transmitted as an offset correction value to the controller of the scanner optic 5 or the x-y-movement unit 5′. By carrying out a field measurement of this type in a plurality of planes parallel to the x-y-working field 7, it is possible to measure and calibrate the x-y-z-focal point throughout the entire working space.

For z-focal point measurements of the laser beam 2, the aperture diameter of the aperture diaphragm 11 also corresponds approximately to the focal diameter of the laser beam 2. The laser beam 2 is displaced in the z-direction within the measurement aperture 12 in the aperture diaphragm 11 in a z-grid by the focusing optic 4 or the z-movement unit 6 and the laser power is measured by the detector 13 at each grid point. The grid distance of the z-grid is preferably of from approximately 0.1 to 1 mm. The peak value, i.e. the z-focal point of the laser beam 2, at each measurement point can then be determined from the measurement values and transmitted as an offset correction value to the controller of the focusing optic 4 or the z-movement unit 6.

A single measurement at the center of the grid is sufficient to check the focal point on the x, y and z axes. The maximum measurement value measured in the preceding measurements along the grid acts as a reference in this case.

For beam profile measurements, the aperture diameter of the aperture diaphragm 11 is many times smaller than the focal diameter of the laser beam. The edge length of the x-y-grid preferably corresponds approximately to the focal diameter of the laser beam 2 and the grid distance is preferably selected to be appropriately small. The beam profile of the laser beam 2 can be established and analyzed using the measurement values of the x-y-grid thus obtained.

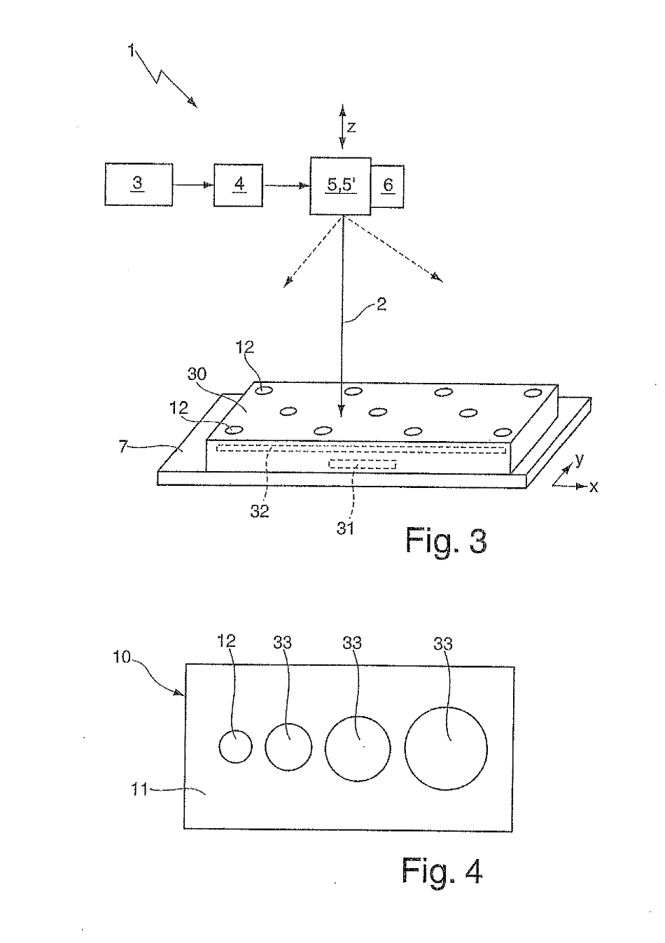

In contrast to the embodiment shown in FIG. 1, in which the same aperture diaphragm 11 is arranged consecutively at the plurality of measurement points, in FIG. 3 an aperture plate 30 comprising a plurality of apertures 12, each defining the measurement points, is arranged in the working field 7. The focal point and beam profile measurements can be carried out as described above with reference to FIG. 1.

Each of the plurality of apertures 12 in the aperture plate 30 may be followed by its own detector or, as shown in FIG. 3, they may be followed by a common central detector 31. In this case, a diffuser 32 may be arranged between the aperture plate 30 and the common detector 31 in order to direct the incident light received via the apertures 12 to the detector 31. By using aperture plates 30 at different heights to the working field 7, it is possible to carry out the field measurement in a plurality of planes parallel to the x-y-working field 7 and to measure and calibrate the x-y-z-focal point throughout the entire working space.

In some implementations, the focal point can be found particularly rapidly by providing the aperture diaphragm 11 which has a measurement aperture 12 of, for example, 0.5 mm, with one or more additional apertures 33, as shown in FIG. 4, with diameters which differ from the diameter of the measurement aperture (for example, with diameters of 6 mm, 4 mm, 2 mm and 1 mm). Measurements are taken at each aperture, in each case starting from the aperture with the largest diameter. The measurement value measured in the measurement aperture with the largest diameter is used as a reference. If the measurement values correspond by approximately +/−5%, then the position for the focal point is determined to be correct on the x, y and z axes. If this is not the case, the measurement values measured in the different apertures serve as a measure of the difference between the actual focal point and that assumed by the controller. In this way, it is possible to narrow the grid, at each grid point of which the focal point is measured, and to measure the focal point particularly rapidly.

A number of embodiments of the invention have been described. Nevertheless, it will be understood that various modifications may be made without departing from the spirit and scope of the invention. Accordingly, other embodiments are within the scope of the following claims.

What is claimed is:

1. A method of determining a property of a laser beam, wherein the property comprises at least one of an x-y-focal point or a beam profile, the method comprising:
moving the laser beam to each of a plurality of measurement points in a working area;
at each measurement point, adjusting a position of the laser beam to each of a plurality of grid points of an x-y-grid across a measurement aperture defined in an aperture diaphragm;
detecting, with the laser beam positioned at each grid point, a power value of the laser beam using a detector arranged behind the aperture diaphragm; and
determining, at each measurement point, the property of the laser beam from the detected power values.

2. The method of claim 1, wherein moving the laser beam comprises deflecting the laser beam in x and y directions by a scanner optic or an x-y-movement unit.

3. The method of claim 2, wherein detecting the power value comprises keeping a scanner axis of the scanner optic or the x-y-movement unit stationary during the detection.

4. The method of claim 1, wherein the determined property is the x-y-focal point, and wherein the aperture diaphragm has a diameter corresponding approximately to a focal diameter of the laser beam.

5. The method of claim 1, wherein the determined property is the x-y-focal point, and wherein the x-y-grid has an edge length of approximately 5 to 100 times a focal diameter of the laser beam.

6. The method of claim 5, wherein the x-y-grid defines a grid distance between the grid points of approximately 0.01 to 1 mm.

7. The method of claim 1, wherein adjusting the position of the laser beam comprises adjusting the position of the laser beam across multiple apertures of differing sizes.

8. The method of claim 1, wherein the determined property is the beam profile, and wherein the aperture diaphragm is of a diameter substantially smaller than a focal diameter of the laser beam.

9. The method of claim 1, further comprising arranging the aperture diaphragm consecutively at each of the plurality of measurement points.

10. The method of claim 1, wherein the working area comprises one of a two-dimensional working field of the laser beam and a three-dimensional working space of the laser beam.

11. The method of claim 1, wherein the aperture diaphragm comprises an aperture plate defining a plurality of apertures that correspond to the measurement points.

12. The method of claim 11, wherein each of the plurality of apertures in the aperture plate is followed by a respective detector that detects the laser power at the measurement point corresponding to the aperture.

13. The method of claim 11, wherein the plurality of apertures in the aperture plate are followed by a common detector that detects the laser power at each of the measurement points.

14. The method of claim 1, further comprising:
at each measurement point, displacing the position of the laser beam to each of a plurality of z-grid points along the z direction within the measurement aperture in the aperture diaphragm;
detecting, with the laser beam positioned at each z-grid point, a second power value of the laser beam by the detector; and
determining, at each measurement point, a z-focal point of the laser beam from the detected second power values.

15. The method of claim 14, wherein the z-grid points are spaced along the z direction by a z-direction spacing of approximately 0.1 to 1 mm.

16. A system for determining a property of a laser beam, the system comprising:
an x-y-beam positioner configured to position a laser beam in x and y directions across a working area;
a z-direction beam positioner for displacing the laser beam in a z direction normal to the working area; and
at least one aperture diaphragm positioned within the working area and associated with a beam power detector.

17. The system of claim 16, wherein the x-y-beam positioner comprises at least one of a scanner optic and an x-y-movement unit.

18. The system of claim 16, wherein the z-direction beam positioner comprises at least one of a focusing optic and a z-movement unit.

19. A method of determining a focal point of a laser beam along a z direction along which the laser beam extends, the method comprising:
moving the laser beam to each of a plurality of measurement points in a working area perpendicular to the z direction;
at each measurement point, displacing a position of the laser beam to each of a plurality of points spaced in the z direction within a measurement aperture defined in an aperture diaphragm;
detecting, with the laser beam positioned at each point, a power value of the laser beam by a detector arranged behind the aperture diaphragm; and
determining, at each measurement point, the focal point of the laser beam from the detected power values.

20. A method of operating a laser beam to process a workpiece across a working area, the method comprising:
determining a property of the laser beam at multiple points across the working area, according to the method of claim 1;
transmitting one or more offset correction values based on the determined property to a controller of the laser beam; and then
processing the workpiece as a function of the one or more offset correction values.
